(19) United States
(12) Patent Application Publication
(10) Pub. No.: US 2024/0424453 A1
(43) Pub. Date: Dec. 26, 2024

(54) METHOD FOR GAS SEPARATION BY MEMBRANES

(71) Applicant: Evonik Operations GmbH, Essen (DE)

(72) Inventors: Tian DING, Shanghai (CN); Jinhua JIANG, Shanghai (CN); Xiao YAO, Huzhou (CN); Zhengyi ZHANG, Shanghai (CN)

(73) Assignee: Evonik Operations GmbH, Essen (DE)

(21) Appl. No.: 18/750,658

(22) Filed: Jun. 21, 2024

(30) Foreign Application Priority Data
Jun. 25, 2023 (WO) PCT/CN2023/102084

(51) Int. Cl. B01D 71/64; B01D 53/22; B01D 69/08

(52) U.S. Cl. CPC B01D 71/641; B01D 53/228; B01D 69/08; B01D 2256/24; B01D 2257/11; B01D 2257/504

(57) ABSTRACT

The present invention discloses multistage membrane apparatus and a method for separating gases from a crude gas stream a gas to be separated, a main remaining gas and optionally one or more further gas components, wherein in the apparatus comprises a feed stream separation stage, a first permeate separation stage and a second permeate separation stage, each stage being a membrane separation stage with gas separation membranes.

### CROSS REFERENCE TO RELATED APPLICATIONS

The present application claims priority under 35 USC § 119 to PCT/CN2023/102084, filed in China on Jun. 25, 2023, the content of which is incorporated herein by reference in its entirety.

### TECHNICAL FIELD

The present invention relates to the separation or recovery of gases from a mixture of gases by permeation thereof through membranes. More particularly, the present invention relates to a specific process and apparatus for the separation of gases such as helium from natural gas, or carbon dioxide from wellhead gas or from flue gas via membranes.

### BACKGROUND ART

In recent years, membrane-based technologies have been increasingly utilized for industrial separation or recovery of gases from a mixture of gases. In industrial separation or recovery of gases, the product purity and the product recovery both are important requirements for membrane-based gas separation processes. Therefore, many kinds of membrane separator systems with the purpose of achieving higher product purity or higher product recovery have been developed.

Two-stage membrane separator systems for example have been used widely in industrial separation of gases. CN112408342A discloses a separation system comprising a primary membrane separator, a secondary first-stage membrane separator, a secondary second-stage membrane separator and a pressure swing adsorption unit. Laguntsov, “Membrane recycle system usage for helium extraction from natural gas”, Physics Procedia, 72 (2015), 93-97 discloses a two-stage membrane circuit used as gas-separation system, where a recycle circuit is applied as the second stage.

U.S. Pat. Nos. 9,314,735 B2, 8,999,038 B2 and U.S. Pat. No. 10,471,380 B2 disclose three-stage membrane separation systems comprising a retentate separation stage producing a retentate stream that is removed from the process as a first product, and a permeate separation stage producing a permeate stream that is removed from the process as a second product. Said processes are characterized in that the permeate stream of the retentate separation stage and the retentate stream of the permeate separation stage are recycled back to the feed stream.

CN 212292809 U discloses a multistage helium extraction device and helium separation system. The system is characterized by a series of membrane separation stages, each stage separates the permeate stream of the previous stage and generates a new permeate stream as well as a new retentate stream. The process of CN 212292809 U is characterized in that between any two adjacent membrane separation stages, from separation stage two to the final separation stage, a recompression unit is needed. The device and separation system are inefficient in terms of energy consumption and invest costs.

U.S. Pat. No. 11,285,434 B2 discloses a multistage membrane process and system for high recovery of a non-permeating gas. The system comprises a series of membrane separation stages, wherein a first permeate obtained from a first separation stage is separated in a second separation stage to obtain a second permeate stream and a second retentate stream. The second permeate stream is fed to a third separation stage, where it is separated into a third permeate stream and a third retentate stream. The third retentate stream is recycled to the crude gas stream on the up-stream side of a first compressor and the second retentate stream is recycled to the feed stream of the first separation stage on the high-pressure downstream side of the first compressor. The process of U.S. Pat. No. 11,285,434 B2 is inefficient in terms of energy consumption for recompression, especially if the crude gas has high own pressure. In such case an additional compressor to recompress the third retentate stream is needed.

A. Ramirez-Santos et al, “Optimization of multistage membrane gas separation processes. Example of application to CO2 capture from blast furnace gas”, Journal of Membrane Science Volume 566, 15 Nov. 2018, Page 359, FIG. 11, discloses several three-stage and four stage membrane separation systems for CO₂ capture from blast furnace gas.

U.S. Pat. No. 6,565,626 B1 discloses a four-stage membrane separation system, wherein the retentate stream produced in a retentate separation stage is withdraws as a first product and the permeate stream obtained from a second permeate separation stage is withdrawn as a second product. The permeate stream of the retentate separation stage and the retentate stream of the first permeate separation stage are recycled back to the feed stream. The retentate stream of the second permeate separation stage is recycled back to the first permeate stream.

Three-stage and four-stage membrane separation systems can significantly increase the product recovery or the product purity compared to two-stage membrane separation systems. However, new multistage membrane separation systems satisfying both higher product recovery and higher product purity at the same time are still needed.

### SUMMARY OF THE INVENTION

The inventive process and apparatus are multistage membrane separation process/apparatus comprising a feed stream separation stage as first separation stage, producing a first retentate stream, which is removed as a second product. They further comprise a second permeate separation stage producing a third permeate stream, which is removed as a first desired product, and a third retentate stream, which is recycled back to the permeate stream obtained from the feed stream separation stage. Compared to prior art processes, the inventive process achieves both higher product recovery and higher product purity at the same time.

Specifically, the present invention discloses a method for separating a gas to be separated and a main remaining gas from a raw gas stream comprising the gas to be separated, the main remaining gas and optionally one or more further gas components, wherein in a multistage membrane apparatus of the invention, comprising a feed stream separation stage, a first permeate separation stage and a second permeate separation stage, each stage being a membrane separation stage with gas separation membranes,
a) a raw gas stream is fed to a feed stream that is fed to the feed stream separation stage (1), where it is separated to a first permeate stream and a first retentate stream, said first retentate stream is removed from the multistage membrane apparatus as second product or further processed or discarded,
b) the first permeate stream obtained in step a) is compressed with compression unit (6) such that after compression, said compressed first permeate stream is fed into the first permeate separation stage (2), where it is separated to a second permeate stream and a second retentate stream,
   preferably the second retentate stream is
recycled to the feed stream
or
recycled to the raw gas stream
or
further processed in the multistage membrane apparatus
or
removed from the multistage membrane apparatus, preferably as third product or to be discarded,
or
combined with the first retentate stream,
   preferably the second retentate stream is recycled to the feed stream or to the raw gas stream or further processed in the inventive multistage membrane apparatus,
c) the second permeate stream is, without compression with a compressor, fed into the second permeate separation stage (4), where it is separated to a third permeate stream, which is removed from the multistage membrane apparatus as first product stream or further processed or removed from multistage membrane apparatus and thereafter further processed, and a third retentate stream, and
d) the third retentate stream is fed to the first permeate stream to obtain a combined gas stream that is fed the compression unit (6) or is fed directly into the compression unit (6).

Process and apparatus of the invention allow to obtain the gas to be separated in the third permeate stream with both higher recovery and higher purity than in prior art processes. This is particularly true for multi gas mixtures comprising at least four or five different gas components.

One particular application of the present invention is helium extraction from natural gas. The present invention may also be applied to the separation of carbon dioxide in wellhead gas and the separation of carbon dioxide in flue gas.

The invention further provides a multistage membrane apparatus which may be used to implement the method of the invention.

Further advantages of the present invention include lower capital expenditure (CAPEX) investment, lower operating expense (OPEX)/energy consumption, and lower maintenance work than prior art processes and apparatuses. As will be shown in Table 3 below, the process of the invention, even though it is carried out in Example 3 as four-stage process, requires less total membrane capacity than the three-stage prior art process of Comparative Example 3, while simultaneously helium recovery and purity are comparable. In addition, the amount of gas to be recompressed by the compressor of Example 3 is lower compared to amount of gas to be recompressed in the three-stage prior art process according to Comparative Example 1, which includes recompression of the second permeate and the third retentate stream. As consequence a smaller compressor can be used in the process of the invention which reduces CPAEX as well as OPEX costs.

The process of the present invention has high operation flexibility with minimized compression power requirement and optimized energy consumption. Crude gases with low own pressure as well as crude gases with very high own pressure can be treated with a maximum of one or two compressors. No additional compressor downstream of the first permeate stream separation stage is needed.

Further advantages of the present invention, which are not stated explicitly, would be apparent for a person skilled in the art upon reading the specification.

### BRIEF DESCRIPTION OF DRAWINGS

FIG. 1 schematically shows the inventive multistage membrane apparatus of Example 1.

FIG. 2 schematically shows the inventive multistage membrane apparatus of Example 2.

### DETAILED DESCRIPTION OF THE INVENTION

Before describing the present invention in detail hereinafter, some important terms are defined.

Membrane capacity as used in the present invention is defined as the product of the membrane surface and the permeance of the membrane that is determined for the gas to be separated, preferably the main component of the third permeate stream, more preferred He, H₂ or CO₂, most preferred He or CO₂ under standard conditions, i.e. a temperature of 22-25° C. and a feed side pressure of 11 bar. Membrane surface respectively membrane area is the external surface of the membrane as macroscopically visible. For its determination it is assumed that the membrane does not have pores and the external surface is homogeneous and smooth. In other words, the membrane surface of a flat membrane calculates as the product of length and width of the flat sheet and the membrane surface of hollow fiber membranes calculates as the product of length and external circumference of the hollow fiber.

If membranes out of different materials are used in different stages and/or if different membranes are used in one stage and/or if different temperatures are used in different stages, the ratio of the membrane capacities is usually different to the ratio of the membrane surfaces. Since such “mixed systems” are covered by the present invention, too, the “membrane capacity” is used as distinguishing feature in preferred embodiments of the invention instead of the “membrane surface”.

It is also possible in the present invention to use more than one membrane in a separation stage. Thus, the total membrane capacity per stage has to be calculated, which is the sum of all individual membrane capacities used in that stage.

Permeance is defined as material flow per time unit, area and differential pressure through a membrane. Permeability on the other hand is defined as material flow per time unit, area, differential pressure and layer thickness through a membrane.

The term selectivity as used and claimed in the present invention to characterize membranes, in each case is the pure gas selectivity, independent whether membranes are used to separate a two or a multi-gas mixture. The selectivity for hollow fiber membranes calculates as quotient of the permeances of two pure gases, and thus states how well the membrane can separate a gas mixture with regard to the two components. For flat sheet membranes, the selectivity is calculated using the permeabilities of two pure gases instead of the permeances.

Permeate refers to the overall stream obtained on the low-pressure side of a membrane, membrane module or membrane separation step. Permeate gas refers in each case to the component(s) enriched in the permeate stream relative to the respective feed stream at the membrane, at the membrane module or in the membrane separation step.

Retentate refers to the entire stream that is obtained on the high-pressure side of a membrane, membrane modules or membrane separation step, and that does not pass through the membrane. Retentate gas refers to the component(s) enriched in each case in the retentate stream relative to the respective feed stream at the membrane, at the membrane module or in the membrane 30 separation step.

The terms crude gas or crude gas mixture or crude gas stream or raw gas are used synonymously and refer to a gas mixture comprising the gas to be separated, the main remaining gas and optionally one or more, preferably two or more, more preferred three or more further gas components, respectively to a stream of said gas mixture, which are to be separated using the method of the present invention and/or the apparatus of the present invention.

Feed stream refers to a gas stream that is supplied to the feed stream separation stage (1). At the start of operation of the process or apparatus of the present invention the feed stream corresponds to crude gas stream. The feed stream may be compressed by a compressor (5). Whether a compressor (5) is used or not depends on the pressure of the crude gas stream. Sometimes the crude gas comes from a source that already has a pressure sufficient to generate the required driving force over the membranes without additional compression or otherwise generation of additional driving force, for example a vacuum device on a permeate side of a membrane separation stage or with a flushing-gas stream. In the most cases, however, the processes and apparatuses of the present invention are configured such, that a compressor (5), is arranged in the feed stream upstream of the feed stream separation stage (1) and/or at least one vacuum device is arranged in at least one of the permeate stream(s), to generate the driving force. After a first separation cycle of the process of the invention the feed stream preferably comprises, more preferably consists of, the raw gas stream and the recycled second retentate stream or the raw gas stream and the recycled fourth retentate stream.

The main remaining gas is a gas component of the raw gas which is enriched in the first retentate stream compared to the raw gas stream and which is the main component of the first retentate stream.

The terms component intended to be separated, component to be separated and gas to be separated are used synonymously and means a gas having a higher permeability through the membranes used in the process and apparatus of the invention than the main remaining component of the raw gas and being enriched in the third permeate stream compared to the raw gas stream. Usually the gas to be separated is the first product gas and/or the main component of the third permeate stream.

Further gas components are interfering gases comprised in the raw gas stream that are different from the gas to be separated and the main remaining gas.

The method according to the present invention is a method for separating a gas to be separated and a main remaining gas from a raw gas. The gas to be separated having higher permeability than the main remaining gas is removed from the process/apparatus of the invention with the third permeate stream with both high recovery and high purity.

Preferably, in at least one separation stage of the process and apparatus of the invention, the selectivity of the membranes for the gas to be separated to the main remaining gas is at least 10, preferably at least 15, more preferably at least 25. Use of high selective membranes contributes to recover of the gas to be separated with high purity from the crude gas stream. In particular, the selectivity for
He/CH₄, determined at 22-25° C. and 11 bar, is preferably at least 30, more preferred at least 60, even more preferred at least 75, and most preferred 100 to 500,
   and/or
the selectivity for CO₂/N₂, determined at 22-25° C. and 11 bar, is preferably at least 15, more preferred at least 20, even more preferred at least 25 and most preferred 30 to 200 and/or
and the selectivity for CO₂/CH₄, determined at 22-25° C. and 11 bar, is preferably at least 20, more preferred at least 30, even more preferred at least 40, and most preferred 50 to 300.

In case the selectivity for the gas to be separated to a further gas component of the raw gas, i.e. an interfering gas, is less than 5, it is preferred that the crude gas stream comprises more gas to be separated than the interfering gas, preferably 5 times more gas to be separated than the interfering gas.

As shown in Examples 3 and 4, membranes with different selectivites can be used in the different separation stages. If membranes with different selectivities are used, it is preferred that the most selective membrane type of all membranes used in the process and apparatus of the invention is used in the third separation stage. This provides benefits in terms of enhanced purity and yield of the gas to be separated.

Preferably the membrane capacities of the separation stages of the present invention are selected such that the highest membrane capacity of all membranes used in the process and apparatus of the invention is used in the first separation stage. This provides benefits because the gas volume at the first separation stage is the biggest.

Preferably the ratio of the membrane capacity of the feed stream separation stage to the membrane capacity of the first permeate stream separation stage is equal to or bigger than 2 more preferred 2 to 100, even more preferred 2 to 70, still even more preferred 2.5 to 50, particular preferred 2.5 to 20 and most preferred 2.5 to 10.

Preferably the ratio of the membrane capacity of the feed stream separation stage to the membrane capacity of the second permeate stream separation stage is equal to or bigger than 2 more preferred 2.5 to 100, even more preferred 3 to 70, still even more preferred 5 to 50, particular preferred 6 to 45 and most preferred 7 to 45.

If a retentate separation stage is present in the device and process of the present invention, it is preferred that membrane capacity of the retentate separation stage is equal to or bigger then the membrane capacity of the first permeate stream separation stage.

More preferred membranes with high, even more preferably the highest, permeance for the gas to be separated compared to all membranes used in the process and apparatus of the invention are used in the first separation stage. High permeance for the gas to be separated can help to save membrane area (membrane amount) and therefore save investment and space etc.

Preferably the pressure at the feed gas inlet of the feed stream separation stage (1) is in a range of from 5 to 200 bara, more preferred 5 to 150 bara, even more preferred 8 to 100 bara and even more preferred 10 to 80 bara, wherein “bara” stands for “bar absolute”, i.e. pressure in the stream plus atmospheric pressure. If the pressure in the raw gas stream is in the ranges defined before, it is preferred not to use any compressor between raw gas and feed stream. If the raw gas pressure, however, is too low, a compressor (5) is preferably arranged in the feed stream to adjust the pressure of the feed stream in the desired range.

The pressure at the permeate gas outlet of the feed stream separation stage, i.e. at the most upstream point of the first permeate stream is preferably <120 bara, more preferred <50 bara, more preferred <10 bara, even more preferred between 1 and 5 bara. The higher the trans membrane pressure over the feed stream separation stage (1) is, the more effective the gas to be separated is separated from the remaining gases.

A compression unit (6), preferably a compressor or a blower, is arranged in the first permeate stream of the invention to recompress the first permeate stream or the first permeate and third retentate stream or the first permeate, third retentate and fourth permeate stream, preferably to a pressure of from 5 to 200 bara, more preferred 5 to 150 bara, even more preferred 8 to 100 bara, even more preferred 10 to 80 bara and most preferred to the same pressure as that of the feed stream plus-minus 10%. This pressure increase generates the driving force of the second and third permeate stream separation stages (2) and (4).

Preferably the trans membrane pressure over the first permeate stream separation stage (2) is smaller than the one over the feed stream separation stage (1). This ensures that the pressure of the second permeate stream is high enough to generate sufficient driving force over the second permeate stream separation stage (4) without the need of an additional compressor in the second permeate stream. Accordingly there is no compressor arranged in the second permeate stream conduit in the present invention. Even though there might be a blower arranged in the second permeate stream conduit (17), it is preferred that neither a compressor nor a blower is arranged in the second permeate stream conduit (17). Abstaining from use of a compressor arranged in the second permeate stream conduit (17) is beneficial for CAPEX as well as for OPEX costs. While using of a blower is also beneficial compared to compressor in terms of CAPEX and OPEX costs, a process using neither a compressor nor a blow in the third permeate stream conduit leads to the lowest CAPEX and OPEX costs. To avoid use of a compressor in the second permeate stream conduit (17), it is preferred to set the trans membrane pressure over the first permeate separation stage (2) such, that the pressure in the second permeate stream is in a range of from 2 to 150 bara, more preferred 2.5 to 100 bara, even more preferred 3 to 50 bara, even more preferred 3 to 25 bara with the proviso that the pressure in the second permeate stream is lower than the pressure of the recompressed first permeate stream. Preferably the pressure in the second permeate stream is adjusted via a pressure control valve 5 (11), preferably a pressure reduction valve 5 (11) arranged in the third retentate stream.

Preferably the pressure in the third permeate stream is set to <70 bara, more preferred 1 to 20 bara, even more preferred between 1 and 2 bara with the proviso that the pressure in the third permeate stream is lower than the pressure of the second permeate stream.

The third retentate stream is recycled in the process of the invention to the first permeate stream to obtain a combined gas stream that is fed to the compression unit (6) or is fed directly into the compression unit (6). In order to allow combination of both streams, the pressure of the third retentate stream is preferably equal to or up to 300% higher than the pressures of the first permeate stream at the upstream side of the compression unit (6).

The same is true if the second retentate or fourth retentate streams are combined with the raw gas stream or the feed stream. Preferably the pressure of the recycled stream, i.e. second retentate or fourth retentate stream, is equal to or up to 50% higher than the pressures of the stream they are forwarded to.

The gas to be separated can be particularly selected from the group consisting of helium, hydrogen and carbon dioxide. Especially, the gas to be separated is helium.

Preferably the main remaining gas at least one other component is a hydrocarbon gas. The hydrocarbon gas can be represented by the general formula CxHy. More particularly, the main remaining gas is CH₄.

Preferably helium is separated from natural gas comprising methane as the main remaining component. More preferred, the natural gas is subjected to a dehydrogenation and/or a decarbonization before entering the inventive process.

Also preferred carbon dioxide is separated from wellhead gas comprising CH₄ as main remaining component and also higher carbohydrons.

Further preferred carbon dioxide is separated from flue gas comprising N₂ as main component and also trace level of SO₂, O₂, CxHy and NOx.

The invention further provides a multistage membrane apparatus comprising
a feed stream separation stage (1), a first permeate separation stage (2), a second permeate separation stage (4), a compression unit (6) and gas conduits, wherein a feed stream conduit (22) is connected to a raw gas stream conduit (12) and a gas inlet of the feed stream separation stage (1),
a first permeate stream conduit (14) is connected to a permeate gas outlet of the feed stream separation stage (1) and a gas inlet of the compression unit (6),
a compressed permeate gas conduit (23) is connected to the gas outlet of the compression unit (6) and the gas inlet of the first permeate separation stage (2),
a first retentate stream conduit (13) is connected to a retentate gas outlet of the feed stream separation stage (1),
a second permeate stream conduit (17) is connected to a permeate gas outlet of the first permeate separation stage (2) and a gas inlet of the second permeate separation stage (4),
a second retentate stream conduit (16) is connected to a retentate gas outlet of the first permeate separation stage (2),
a third permeate stream conduit (19) is connected to the permeate gas outlet of the second permeate separation stage (4),
a third retentate stream conduit (18) is connected to a retentate gas outlet of the second permeate separation stage (4) and to the first permeate stream conduit (14) up-stream of the compression unit (6) or to the compression unit (6),
wherein
each separation stage (1), (2) and (4) being a membrane separation stage with gas separation membranes,
and wherein
the feed stream separation stage (1) is configured to separate a feed stream comprising the gas to be separated, the main remaining gas and optionally one or more further gas component into a first permeate stream and a first retentate stream,
the first permeate separation stage (2) is configured to separate the compressed gas stream obtained from compression unit (6), into a second permeate stream and a second retentate stream, the second permeate separation stage (4) is configured to separate the second permeate stream into a third permeate stream and a third retentate stream, and
the apparatus being characterized in that there is no compressor arranged in the second permeate stream conduit (17), i.e. between the first permeate separation stage (2) and the second permeate separation stage (4).

Preferably the apparatus of the invention additionally comprises a retentate separation stage (3) connected to the retentate gas outlet of the first permeate separation stage (2) via the second retentate stream conduit (16). In this embodiment the apparatus comprises
a fourth permeate stream conduit (21) connected to a permeate gas outlet of the retentate separation stage (3) and preferably also to the third retentate stream conduit (18) up-stream of the compression unit (6) or to the first permeate stream conduit (14) up-stream of the compression unit (6) or to the compression unit (6), and
a fourth retentate stream conduit (20) connected to a retentate gas outlet of the retentate separation stage (3) and preferably also to the feed stream conduit or the to a raw gas stream conduit.

In case the inventive apparatus does not comprise the retentate separation stage (3) it is preferred that the second retentate stream conduit (16) is connected to the retentate gas outlet of the first permeate separation stage (2) and to the feed stream conduit (22), if the feed stream conduit (22) comprises a compressor (5) it is preferred that the second retentate stream conduit (17) is fed to a connection point up-stream of compressor (5), or the raw gas stream conduit (12) or to a gas removal device.

The inventive apparatus preferably comprises one or more identical or different control valves, preferably pressure control valves, to adjust the pressures of the gas streams within the system. More preferred the apparatus comprises control valve 1 (7) arranged in the first retentate stream conduit (13) and/or a control valve 2 (8) connected to the first permeate stream conduit (14) and/or the gas conduit (15) and further connected to the compressed permeate gas conduit (23) and/or a control valve 3 (9) arranged in the second retentate stream conduit (16) and/or control valve 4 (10) arranged in the fourth retentate stream conduit (20) and/or a control valve 5 (11) in the third retentate stream conduit (18).

Preferably control valve 1 (7) is a pressure control valve, which is used to adjust the retentate pressure and can be used to adjust the trans membrane pressure of the feed stream separation stage (1).

Preferably control valve 2 (8) is a pressure control valve, which is used to adjust the trans membrane pressure and the pressure at the permeate gas outlet of the feed stream separation stage (1) optionally together with pressure control valve 1 (7).

Preferably control valve 3 (9) is a pressure control valve, which is used to adjust the retentate pressure and can be used to adjust the trans membrane pressure of the first permeate separation stage (2).

Preferably control valve 4 (10) is a pressure control valve, which is used to adjust the retentate pressure and can be used to adjust the trans membrane pressure of the first permeate separation stage (2) and/or of the retentate separation stage (3).

Preferably control valve 5 (11) is a pressure control valve, which is used to adjust the retentate pressure and can be used to adjust the trans membrane pressure of the second permeate separation stage (4). It is preferably also used to adjust the pressure at the permeate gas outlet of first permeate separation stage (2).

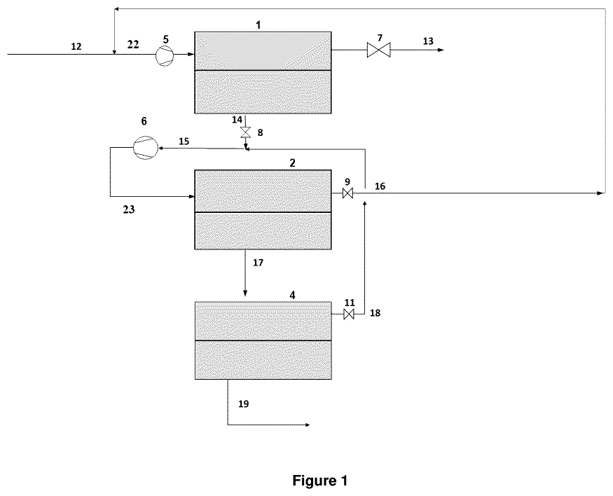

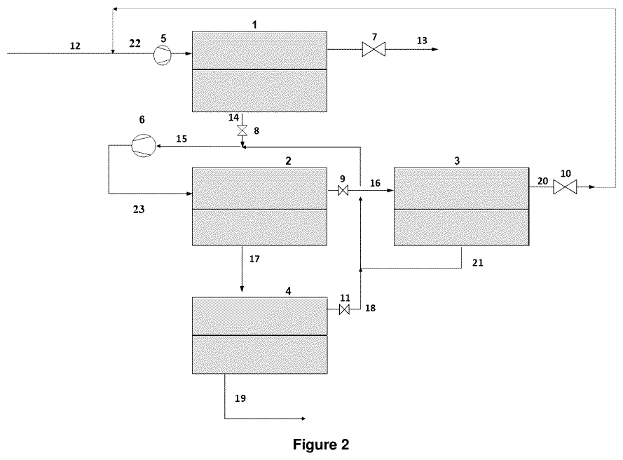

FIG. 1 schematically shows the multistage membrane apparatus of the invention, wherein a feed stream in a feed stream conduit (12) is separated in a feed stream separation stage (1) into a first retentate stream (i.e., second product stream) in a first retentate conduit (13) and a first permeate stream in a first permeate conduit (14) optionally with pressure reduction by an optional pressure-control valve 2 (8) arranged in the first permeate conduit (14) to boost the partial pressure difference between the feed side and the permeate side in the feed stream separation stage (1) so as to facilitate the permeation of the gases to be separated through the membrane, thus the membrane capacity needed for the separation stage could be reduced. Advantageously, the pressure is set as defined above by means of the pressure-control valve 2 (8). The first permeate stream is then recompressed by compression unit (6) connected to the first permeate stream conduit (14). After a first purification cycle of the inventive process, the first permeate stream and the third retentate stream are combined in conduit (15) and recompressed by compression unit (6), so that it can be efficiently separated in the first permeate separation stage (2) to the second retentate stream in the second retentate stream conduit (16) and a second permeate stream in the second permeate stream conduit (17). The second permeate stream is without compression with a compressor fed into the second permeate separation stage (4). Preferably, the pressure of the second permeate stream is controlled by means of a pressure-control valve 5 (11) arranged in the third retentate conduit (18). The second permeate separation stage (4) produces a third permeate stream in the third permeate stream conduit (19), which is enriched in the gas to be separated compared to the raw gas stream, and a third retentate stream in the third retentate stream conduit (18) that is recycled back to the first permeate stream to form combined gas stream, which is subjected to a recompression with compression unit (6). Alternatively (not shown in FIG. 1), the third retentate stream can be recycled back via the third retentate stream conduit (18) directly to the compression unit (6). The third permeate stream (19) is enriched in the gas to be separated as the desired separated product and is withdrawn from the multistage membrane apparatus of the invention or may be further processed after withdrawal, preferably by dehydrogenation and/or decarbonization and/or deep purification. The first retentate stream (13) and the second retentate stream (16) are removed from the multistage membrane apparatus to be either further processed to recover additional product or withdrawn directly as natural gas product (not shown in FIG. 1). Alternatively and preferably, as shown in FIG. 2, the second retentate stream (16) may be recycled back to the feed stream (12).

If the feed stream has pressure in the preferred range of 5 to 200 bara, it is preferred that a similar pressure of the recompressed first permeate stream is set by the compression unit (6). A similar pressure of the recompressed first permeate stream is the required driving force for the second retentate stream for recycling back to the feed stream (12). Alternatively, a recycle compressor (not shown in FIG. 1) may be arranged in the second retentate stream (16) to compress the said stream to the required pressure for recycling.

Further alternatively, if a compressor (5) is present between the raw gas stream and the feed stream, the pressure of the recompressed first permeate stream and also that of the second retentate stream may be lower than the pressure of the feed stream but similar to or higher than the pressure of the raw gas stream so that the second retentate stream may be recycled, preferably without further recompression, to the up-stream side of the compressor (5) (as shown in FIG. 1) or, if a multi-stage compressor is used, to a compression stage of the compressor (5) with similar pressure compared to the second retentate stream.

Said recycling of the second retentate stream (16) benefits the recovery of the gases to be separated, and therefore increases the partial pressure of the gases in the feed stream, which further facilitates the permeation of the gases through the membrane.

FIG. 2 schematically shows another preferred method and apparatus of the invention. In FIG. 2, a multistage membrane system is shown which comprises an additional retentate separation stage (3). The feed stream is sent via the feed stream conduit (12) to a feed stream separation stage (1), which generates a first retentate stream in the retentate stream conduit (13) that is withdrawn as the second product stream. The first permeate stream obtained from the feed stream separation stage (1) with pressure reduction by means of an optionally present pressure-control valve 2 (8) is recompressed by the compressor (6). After a first purification cycle of the inventive process, the first permeate stream and the third retentate stream and the fourth permeate stream are combined and the combined gas stream in the gas stream conduit (15) is re-compressed by compression unit (6), and then sent to the first permeate separation stage (2). Advantageously, the controlled pressure drop over the feed stream separation stage (1) by the pressure-control valve 2 (8) could be extended to a pressure as defined above. The second permeate stream from the first permeate separation stage (2) is sent via the second permeate stream conduit (17) directly to the second permeate separation stage (4) to produce the desired first product stream (the third permeate stream) in the third permeate stream conduit (19). Preferably, a pressure-control valve 5 (11) is arranged in the third retentate stream conduit (18) to control the pressure of the second permeate stream so that the concentration of the gas to be separated, i.e. the desired product, in the third permeate stream can be efficiently increased. The second retentate stream is further separated in the retentate separation stage (3) into a fourth retentate stream in the fourth retentate stream conduit (20) that is withdrawn from the membrane separation system as third product stream (not shown in FIG. 2), and a fourth permeate stream in the fourth permeate stream conduit (21) that is recycled together with the third retentate stream to the first permeate stream for recompression to compression unit (6). Alternatively and preferably, the fourth retentate stream may be recycled back to the feed stream (12) or the raw gas stream via the fourth retentate stream conduit (20).

As explained for the second retentate stream of FIG. 1, the fourth retentate stream in FIG. 2 needs to have similar pressure than the feed stream or the raw gas stream if being recycled to one of those streams. Thus, if the feed stream pressure is in the preferred range of 5 to 200 bara, it is preferred that a similar pressure of the re-compressed first permeate stream is set by the compression unit (6).

Alternatively, a recycle compressor (not shown in FIG. 2) may be arranged in the fourth retentate stream (20) to compress the said stream to the required pressure for recycling.

Further alternatively, if a compressor (5) is present between the raw gas stream and the feed stream, and the pressure of the fourth retentate stream is lower than the pressure of the feed stream but similar or higher than the pressure of the raw gas stream, the fourth retentate stream may be recycled, preferably without further recompression, to the up-stream side of the compressor (5) (as shown in FIG. 2) or, if a multi-stage compressor is used, to a compression stage of the compressor (5) with similar pressure compared to the fourth retentate stream.

The inventive apparatus or the process according to the invention can in principle be implemented with all membranes which are capable of separating binary gas mixtures or multigas mixtures. The membrane materials used are preferably but not exclusively polymers. Useful polymers in the separation-active layer are more preferably polyimides, polyetherimides, polyaramides, polybenzoxazoles, polybenzothiazoles, polybenzimidazoles, polyamides, polysulfones, cellulose acetates and derivatives, polyphenylene oxides, polysiloxanes, polymers with intrinsic microporosity, mixed matrix membranes, facilitated transport membranes, polyethylene oxides, polypropylene oxides, carbon membranes or zeolites, or mixtures thereof.

Preferably, membranes containing a separation layer of a glassy polymer, i.e. a polymer having a glass transition point at a temperature above the operating temperature of the membrane separation stage, will provide higher permeability for carbon dioxide than for methane. The glassy polymer may be a polyetherimide, a polycarbonate, a polyamide, a polybenzoxazole, a polybenzimidazole, a polysulfone or a polyimide and the gas separation membrane preferably comprises at least 80% by weight of a polyimide or a mixture of polyimides.

Further preferred membranes can be used including as materials for the separation-active layer, or as a material for the complete membrane, a polyimide of structure (I)

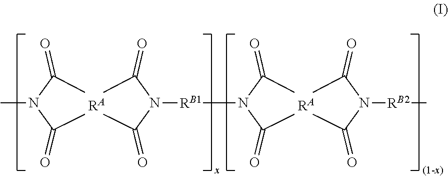

where the aromatic dianhydride monomer units R^{A}, independently of one another, are selected from the group consisting of:

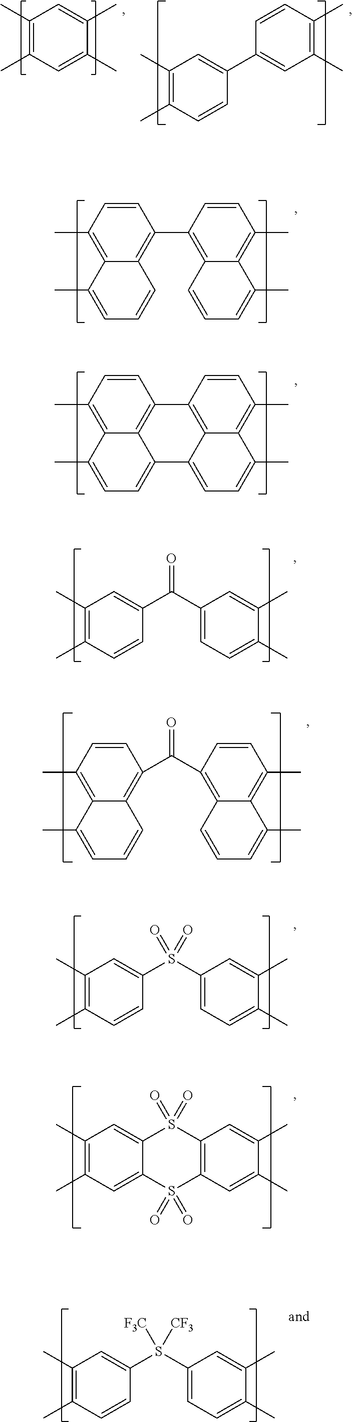

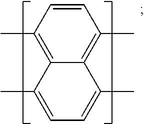

the aromatic diamine monomer units R^{B1}, independently of one another, are selected from the group consisting of:

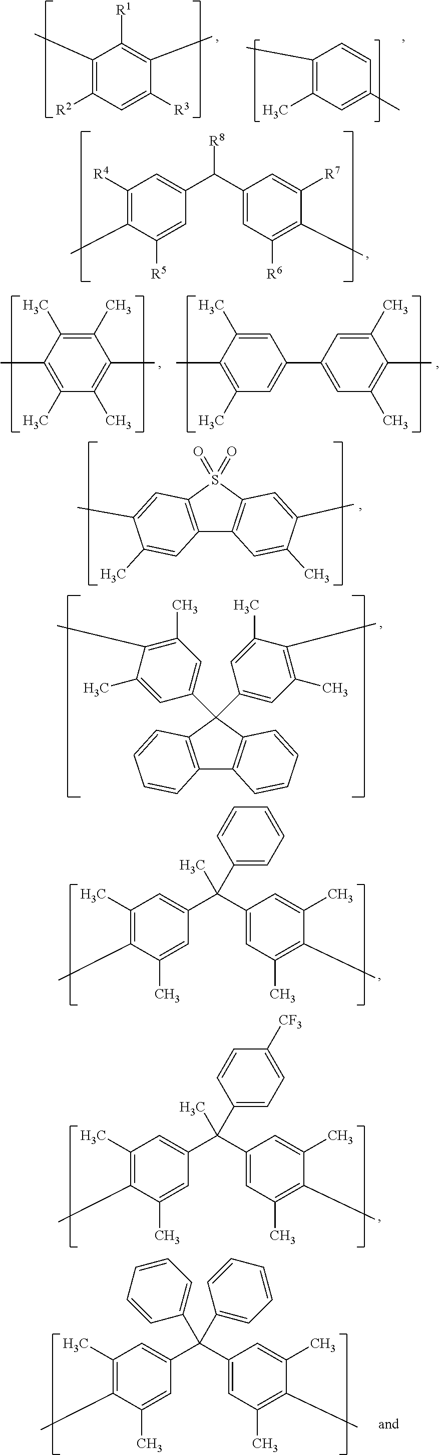

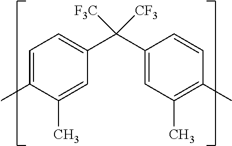

with each R¹ to R⁷ independently of each other being hydrogen or a methyl group with the proviso that at least one of R¹ to R³ is different from hydrogen, and at least one of R⁴ to R⁷ is different from hydrogen;
R⁸ being hydrogen or a C₁ to C₃ alkyl group unsubstituted or substituted by one or more halogen groups such as fluoro-, chloro- and bromo-group, preferably hydrogen or methyl;
and the aromatic diamine monomer units R^{B2}, independently of one another, are selected from the group consisting of:

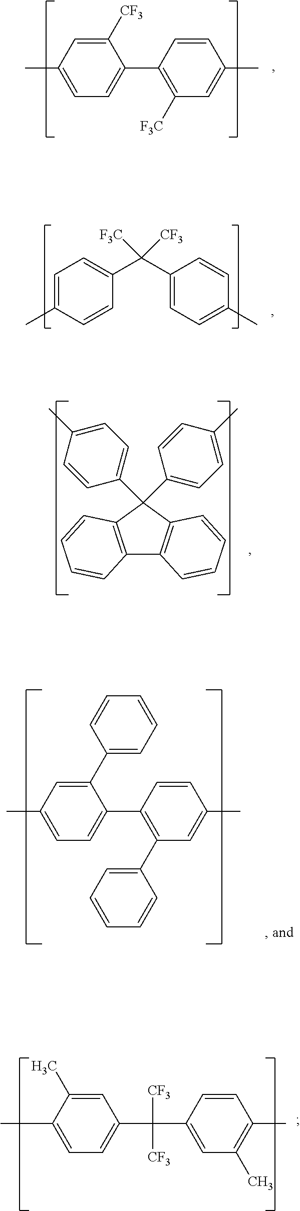

and x is from 0.1 to 1, for example 0.15 to 1, 0.2 to 1, 0.25 to 1, 0.3 to 1, 0.35 to 1, 0.4 to 1, 0.45 to 1, 0.5 to 1, 0.55 to 1, 0.6 to 1, 0.65 to 1, 0.7 to 1, 0.75 to 1, 0.8 to 1, 0.85 to 1, 0.9 to 1, 0.95 to 1.

More preferred, the gas separation membranes used in the present invention comprise at least 50% by weight of a polyimide prepared by reacting a dianhydride selected from 3,4,3′,4′-benzophenonetetracarboxylic dianhydride, 1,2,4,5-benzenetetracarboxylic dianhydride, 3,4,3′,4′-biphenyltetracarboxylic dianhydride, oxydiphthalic dianhydride, sulphonyldiphthalic dianhydride, 1,1,1,3,3,3-hexafluoro-2,2-propylidenediphthalic dianhydride and mixtures thereof with a diisocyanate selected from 2,4-tolylene diisocyanate, 2,6-tolylene diisocyanate, 4,4′-methylenediphenyl diisocyanate, 2,4,6-trimethyl-1,3-phenylene diisocyanate, 2,3,5,6-tetramethyl-1,4-phenylene diisocyanate and mixtures thereof.

The dianhydride is preferably 3,4,3′,4′-benzophenonetetracarboxylic dianhydride or a mixture of 3,4,3′,4′-benzophenonetetracarboxylic dianhydride and 1,2,4,5-benzenetetracarboxylic dianhydride. The diisocyanate is preferably a mixture of 2,4-tolylene diisocyanate and 2,6-tolylene diisocyanate or a mixture of 2,4-tolylene diisocyanate, 2,6-tolylene diisocyanate and 4,4′-methylenediphenyl diisocyanate. Suitable polyimides of this type are commercially available from Evonik Fibres GmbH under the trade name P84® type 70, which has CAS number 9046-51-9 and is a polyimide prepared from 3,4,3′,4′-benzophenonetetracarboxylic dianhydride and a mixture of 64 mol % 2,4-tolylene diisocyanate, 16 mol % 2,6-tolylene diisocyanate and 20 mol % 4,4′-methylenediphenyl diisocyanate, and under the trade name P84® HT, which has CAS number 134119-41-8 and is a polyimide prepared from a mixture of 60 mol % 3,4,3′,4′-benzophenonetetracarboxylic dianhydride and 40 mol % 1,2,4,5-benzenetetracarboxylic dianhydride and a mixture of 80 mol % 2,4-tolylene diisocyanate and 20 mol % 2,6-tolylene diisocyanate. The gas separation membranes of this embodiment have preferably been heat treated in an inert atmosphere as described in WO 2014/202324 A1.

In another preferred embodiment, the gas separation membrane comprises at least 50% by weight of a block copolyimide as described in WO 2015/091122 on page 6, line 20 to page 16, line 4. The block copolyimide preferably comprises at least 90% by weight of polyimide blocks having a block length of from 5 to 1000, preferably from 5 to 200.

Membranes made of the preferred polyimides are available from Evonik Fibres GmbH under the name SEPURAN®. More preferably a SEPURAN® Noble membrane supplied by Evonik Fibres GmbH is used. A process for producing these preferred membranes is disclosed in e.g. WO 2019/165597 A1, WO 2011/009919 A1, WO 2014/202324 A1 and WO 2015/091122 A1. Membranes disclosed in this publication can always be used with preference in the method of the present invention. To avoid pure repetition, the content of this patent application is hereby incorporated herein in its entirety by reference. It was found that these membranes gave very good separation outcomes. The membranes are preferably used in the form of hollow fiber membranes and/or flat membranes. The membranes are assembled into modules, which are then used in the separation task. The modules used may be all gas separation modules known in the prior art, for example but not exclusively hollow fiber gas separation modules, spiral-wound gas separation modules, cushion gas separation modules or tube bundle gas separation modules.

### Measurement Methods:

### Selectivity of Membranes

Gas permeabilities are reported in barrers (10⁻¹⁰ cm³·cm⁻²·cm·s⁻¹·cmHg⁻¹). Permeances of hollow fiber membranes to gases are reported in GPU (Gas Permeation Unit, 10⁻⁶ cm³·cm⁻²·s⁻¹·cmHg⁻¹).

### Flat Membranes

For determination of the selectivity of flat membranes permeabilities to pure gases are measured by the pressure rise method. A flat sheet film between 10 and 70 μm in thickness has a pure gas applied to it from one side. On the other side, the permeate side, there is a vacuum (ca. 10⁻² mbar) at the start of the test. Then, pressure rise on the permeate side over time is recorded.

The polymer's permeability can be computed by the following formula:

$$P = \frac{{V}_{d e a d} \cdot {MW}_{g a s} \cdot l}{ρ . R . T . A . Δ p} \cdot \frac{d p}{d t} \cdot {10}^{10}$$

P . . . Permeability in barrers (10⁻¹⁰ cm³·cm⁻²·cm·s⁻¹·cmHg⁻¹)
V_{dead} . . . Volume of permeate side in cm³
MW_{gas} . . . Molar mass of gas in g·mol⁻¹
I . . . Thickness of film in cm
ρ . . . Density of gas in g·cm⁻³
R . . . Gas constant in cm³·cmHg·K⁻¹·mol⁻¹
T . . . Temperature in kelvins (room temperature, 22-25° C.)
A . . . Area of film in cm² (˜12 cm²)
Δp . . . Pressure difference between feed and permeate side in cmHg (11 bara)
dp/dt. Pressure rise per time on permeate side in cmHg·s⁻¹

The selectivity of the flat membrane according to the present invention for various pairs of gases is a pure-gas selectivity. It is calculated from the ratio of permeabilities of the pure gases as follows:

$$S = \frac{{P}_{1}}{{P}_{2}}$$

S . . . pure gas selectivity
P₁ . . . permeability of gas 1
P₂ . . . permeability of gas 2

### Hollow Fiber Membranes

The permeance of hollow fibers is measured using a volume rise method. For this, the flux (at standard temperature and standard pressure) at the permeate site at constant pressure is measured.

For hollow fibers it is necessary to measure the permeance P/I since the thickness of the separating layer is unknown. The permeance is computed by the following formula:

$$P / l = \frac{Q ( S T P )}{R . T . A . Δ p} \cdot {10}^{6}$$

P/I . . . permeance in GPU (gas permeation units. 10⁻⁶ cm³·cm⁻²·s⁻¹·cmHg⁻¹)
Q . . . gas flux of permeate side in cm³ (STP)/s
R . . . gas constant in cm³·cmHg·K⁻¹·mol⁻¹
T . . . temperature in kelvins (room temperature, ˜22 to 25° C.)
A . . . membrane surface, i.e. external area as defined above, of hollow fiber in cm² (between 60 and 80 cm²)
Δp . . . pressure difference between feed and permeate side in cm Hg (11 bara)

The selectivity of the hollow fiber membrane according to the present invention for various pairs of gases is a pure-gas selectivity. It is calculated from the permeances of the pure gases as follows:

$$S = \frac{{P}_{1}}{{P}_{2}}$$

S . . . pure gas selectivity
P₁ . . . permeance of gas 1
P₂ . . . permeance of gas 2

### EXAMPLES

The following examples are provided to illustrate one or more preferred embodiments of the invention but are not limited embodiments thereof. Numerous variations can be made to the following examples that lie within the scope of the invention.

The examples below are based on simulation calculations. The membrane flux and recovery were predicted by the composition of the feed gas and the operating conditions. The data were imported into engineering simulation software (Aspen HYSIS). The membrane stage arrangement and the membrane area in each stage were adjusted. The flux and recovery of membranes at all stages were inversed with simulated data and resubstitued into the simulation software to iterate until material is stable. The following simulated processes are all set under membrane operating temperature ranges. The membranes used for simulation are from Evonik Fibres GmbH under the name SEPURAN® Noble.

### Example 1

As shown in FIG. 1, a crude gas stream having the composition as summarized in Table 1 (which was a natural gas stream) was introduced into the inventive multistage membrane apparatus. The crude gas stream was compressed by a compressor (5) and fed into a feed stream separation stage (1) having a membrane capacity of 365000 He GPU·m². The pressure of the compressed feed stream was 18.1 bara. From the feed stream separation stage (1) a first retentate stream having a content of 88.8 Vol. % methane, 11.0 Vol. % N₂, 0.1 Vol. % He and 0.1 Vol. % in sum from H₂ and CO₂ and a first permeate stream were obtained. The permeate at the permeate gas outlet of the feed stream separation stage (1) had pressure of 1.2 bara that was controlled by a pressure-control valve 2 (8) connected to the first permeate stream conduit (14). The first permeate stream was re-compressed by compressor (6) to a pressure of 10.08 bara and then fed into the first permeate separation stage (2), having a membrane capacity of 137000 He GPU·m², and separated to a second retentate stream and a second permeate stream. The second retentate stream had a composition of 72.1 Vol. % methane, 14.3 Vol. % N₂, 12.0 Vol. % He, 1.5 Vol. % H₂ and 0.1 Vol. % CO₂ and was recycled to crude gas stream. The second permeate stream had a pressure of 3.2 bara, that was controlled by a pressure control valve 5 (11) arranged in the 3^{rd} retentate stream conduit (18), was further fed into a second permeate separation stage (4), having a membrane capacity of 45500 He GPU·m², where it was separated to obtain a 3^{rd} permeate stream and a 3^{rd} retentate stream. The third permeate stream had a composition of 4.8 Vol. % methane, 2.1 Vol. % N₂, 83.7 Vol. % He, 9.2 Vol. % H₂ and 0.2 Vol. % CO₂. The third retentate stream was recycled to the first permeate stream to obtain a combined gas stream that was re-compressed by compressor (6) to 10.08 bara. The inventive multistage membrane apparatus provided a He recovery of 96.8%.

TABLE 1

| composition | Vol. % | Comment |
|---|---|---|
| He | 4.4 | Gas to be separated |
| H₂ | 0.5 | Further gas component |
| CH₄ | 84.54 | Main remaining gas |
| N₂ | 10.55 | Further gas component |
| CO₂ | 0.01 | Further gas component |

### Comparative Example 1

In Comparative Example 1, the membrane apparatus consisted of two stages, a feed stream separation stage, having a membrane capacity of 228000 He GPU·m², and a permeate separation stage, having a membrane capacity of 91000 He GPU·m². The feed stream of the feed stream separation stage of Comparative Example 1 had the same feed pressure and the same composition as Example 1. The feed stream was fed into the feed stream separation stage which generated a first retentate stream being the first product stream and a first permeate stream. The first permeate stream from the feed stream separation stage was compressed by a compressor and then sent to the permeate separation stage, which generated a second retentate stream and a second permeate stream. The second permeate stream was removed from the apparatus as a second product stream, and the second retentate stream was recycled back to the uncompressed crude gas stream. The second retentate stream, i.e. the second product stream, of Comparative Example 1 had a composition of 84.71 Vol. % methane, 14.42 Vol. % N₂, 0.53 Vol. % He, 0.34 Vol. % H₂. The second permeate from the permeate stream had a content of 35.75 Vol. % methane, 9.63 Vol. % N₂, 49.17 Vol. % He, 5.33 Vol. % H₂ and 0.12 Vol. % CO₂. This two-stage membrane apparatus provided a He recovery of 92.3%.

It can be seen that the He recovery of the two-stage membrane apparatus of Comparative Example 1 is much lower than that of the inventive membrane apparatus of Example 1, and the recovered He purity of the two-stage membrane apparatus of Comparative Example 1 is significantly lower than the inventive membrane apparatus of Example 1.

### Example 2

As shown in FIG. 2, a crude gas stream having the composition as summarized in Table 1 was introduced into the inventive multistage membrane apparatus. The crude gas stream was compressed by a compressor (5) and fed into the feed stream separation stage (1), having a membrane capacity of 365000 He GPU·m². The feed pressure of the apparatus was 18.1 bara. The setting led to a first retentate stream having a content of 88.9 Vol. % methane, 11.0 Vol. % N₂, 0.1 Vol. % He and a first permeate stream. The permeate at the permeate gas outlet of the feed stream separation stage (1) had pressure of 1.2 bara that was controlled by the pressure-control valve 2 (8). The first permeate stream was re-compressed by compressor (6) to a pressure of 10.03 bara and then fed into the first permeate separation stage (2), having a membrane capacity of 91000 He GPU·m². The fourth retentate stream from the retentate separation stage (3), having a membrane capacity of 137000 He GPU·m², had a composition of 81.9 Vol. % methane (main remaining gas), 16.2 Vol. % N₂, 1.3 Vol. % He, 0.5 Vol. % H₂ and 0.1 Vol. % CO₂ and was recycled back to the crude gas stream. The permeate of first permeate separation stage (2) had a pressure of 3.1 bara that was controlled by pressure control valve 5 (11) in the third retentate stream conduit (18), was fed into the second permeate separation stage (4), having a membrane capacity of 45500 He GPU·m². Thus, a third permeate stream with a composition of 4.6 Vol. % methane, 2.1 Vol. % N₂, 83.8 Vol. % He, 9.3 Vol. % H₂ and 0.2 Vol. % CO₂ having a pressure of 1.2 bara was obtained. The third retentate stream obtained from the second permeate separation stage (4) was combined with the fourth permeate stream obtained from the retentate 21eparateion stage (3) and fed to the first permeate stream to form a combined gas stream that was re-compressed with a compressor (6) to 10.03 bara. This inventive multistage membrane apparatus provided a He (gas to be separated) recovery of 98.1%.

### Comparative Example 2

In Comparative Example 2, the membrane apparatus consisted of three stages, a feed stream separation stage, having a membrane capacity of 137000 He GPU·m², a permeate separation stage, having a membrane capacity of 45500 He GPU·m², and a retentate separation stage, having a membrane capacity of 137000 He GPU·m², wherein the feed stream having the same feed pressure and the same composition as in Example 2 introduced into the feed stream separation stage and separated into a first retentate stream that was sent to the retentate separation stage, a first permeate stream that was re-compressed by a compressor from 1.2 bara to 10 bara and then sent to the permeate separation stage, the 3^{rd} permeate stream obtained from the permeate separation stage and having a pressure of 1.2 para as well as a composition of 22.11 Vol. % methane, 6.40 Vol. % N₂, 64.63 Vol. % He, 6.71 Vol. % H₂ and 0.15 Vol. % CO₂ was removed from the system as a product stream. The 3^{rd} retentate stream obtained from the permeate separation stage and the permeate stream from the retentate separation stage were recycled back to the crude gas stream. In Comparative Example 2, the retentate from the feed stream separation stage was sent to the retentate separation where it was separated to a 2^{nd} retentate stream having a content of 88.9 Vol. % methane, 10.8 Vol. % N₂, 0.2 Vol. % He and 0.1 Vol. % H₂ and a 2^{nd} permeate stream. This three-stage membrane apparatus provided a He recovery of 95.2%.

It can be seen that compared to the apparatus of Comparative Example 2, the inventive membrane apparatus of Example 2 achieves not only higher He recovery but also higher He purity. Compared to the membrane system of Example 1, the inventive membrane apparatus of Example 2 with an additional retentate separation stage still boost the He yield.

### Example 3

A crude gas stream having the composition as summarized in Table 2 below was introduced into the inventive multistage membrane apparatus as the one shown in FIG. 2 except that there was no compressor (5). The crude gas stream without additional compression was directly fed into the feed stream separation stage (1), having a membrane capacity of 90000 He GPU·m². The pressure of the feed stream was 20 bara. The feed stream was fed to the feed stream separation stage (1) at flowrate of 200 Nm³/h. The feed stream separation stage separated the feed stream to a first retentate stream having a flowrate of 168 Nm³/h and a content of 94.6 Vol. % methane (main remaining gas), 5.3 Vol. % N₂ and 0.1 Vol. % He and a first permeate stream. The permeate of feed stream separation stage (1) having a volume flow rate of 32 Nm³/h and a pressure of 1.2 bara, that was controlled by a pressure-control valve 2 (8). The first permeate stream, was compressed by compressor (6) to a pressure of 20 bara and then fed into the first permeate separation stage (2), having a membrane capacity of 20000 He GPU·m², where it was separated to a second permeate (17) and a 2^{nd} retentate stream. The second retentate stream was forwarded to the retentate separation stage (3), having a membrane capacity of 20000 He GPU·m², where it was separated to a fourth retentate stream and a fourth permeate stream. The fourth retentate stream had a volume flow rate of 30 Nm³/h and a composition of 92.0 Vol. % methane and 7.8 Vol. % N₂, 0.1 Vol. % He, and in sum 0.1 Vol. % from O₂, CO₂, C₂H₆ and H₂ was removed from the system. The 2^{nd} permeate stream had a volume flow rate of 10 Nm³/h and a pressure of 3.1 bara, that was controlled by a pressure-control valve 5 (11) arranged in the 3^{rd} retentate conduit (18), and was fed into the second permeate separation stage (4), having a membrane capacity of 10000 He GPU·m², where it was separated to a 3^{rd} permeate stream and a 3^{rd} retentate stream. The third permeate stream had a volume flow rate of 2 Nm³/h, with a composition of 13.93 Vol. % methane, 2.9 Vol. % N₂, 78.8 Vol. % He, 2.91 Vol. % H₂, 0.36 Vol. % O₂ and 1.1 Vol. % CO₂, was obtained. The third retentate stream from the second permeate separation stage (4) with flowrate of 8 Nm³/h was combined with the fourth permeate stream from the retentate separation stage (3) with flowrate of 8 Nm³/h and the first permeate stream and re-compressed. This inventive multistage membrane apparatus provided a He (gas to be separated) recovery of 90.6%.

TABLE 2

| composition | Vol. % | Comment |
|---|---|---|
| He | 0.75 | Gas to be separated |
| CH₄ | 93.55 | Main remaining gas |
| N₂ | 5.64 | Further gas component |
| CO₂ | 0.01 | Further gas component |
| H2 | 0.03 | Further gas component |
| O2 | 0.01 | Further gas component |
| C2H6 | 0.01 | Further gas component |

### Comparative Example 3

In Comparative Example 3, the membrane system according to U.S. Pat. No. 9,314,735 A was used with the modification that a compressor being arranged in the combined recycling streams rather than in the feed stream. The system comprises three membrane separation stages, a feed stream separation stage, having a membrane capacity of 90000 He GPU·m², a permeate separation stage, having a membrane capacity of 10000 He GPU·m², and a retentate separation stage having a membrane capacity of 160000 He GPU·m². The feed stream used in Comparative Example 3 having the same the same composition as in Example 3 and was sent to the feed stream separation stage where it is separated to a first retentate stream and a first permeate stream. The first retentate stream being sent to the retentate separation stage and the first permeate stream being directly sent to the permeate separation stage without recompression. The permeate stream obtained from the permeate separation stage (the second permeate stream) was removed from the system as a product stream. The retentate stream obtained from the permeate separation stage and the permeate obtained stream from the retentate separation stage were combined, recompressed to the feed pressure by means of a compressor and then recycled back to the feed stream. In Comparative Example 3, the pressure drop over feed stream separation stage extended to 3 bara. The pressure drop over retentate separation stage extended to 1.2 bara. The residue stream leaving the retentate separation stage had a content of 94.2 Vol. % methane, 5.7 Vol. % N₂, 0.01 Vol. % C2H6, 0.01 Vol. % H2, 0.01 Vol. % O2 and 0.07 Vol. % He, analogue to the first retentate stream in Example 3. The second permeate stream as a product stream had a volume flow rate of 2 Nm³/h with a composition of 15.22 Vol. % methane, 2.31 Vol. % N₂, 78.6 Vol. % He, 2.59 Vol. % H₂, 1.11 Vol. % CO₂ and 0.17 Vol. % O₂. The three-stage membrane apparatus provided a He recovery of 90.9%.

The parameters of the simulations of Example 3 and Comparative Example 3 are listed in Table 3 below:

TABLE 3

| Feature | Example 3 | | Comparative Example 3 | |
|---|---|---|---|---|
| Operating temperature | 30° | C. | 30° | C. |
| The number of membranes in feed | 9 | | 9 | |
| stream separation stage | | | | |
| Flowrate of first permeate stream | 32 | Nm³/h | 41 | Nm³/h |
| Pressure of first permeate stream | 1.2 | bara | 3 | bara |
| The number of membranes in first | 2 | | 1 | |
| permeate separation stage | | | | |
| Flowrate of second permeate stream | 10 | Nm³/h | 2 | Nm³/h |
| Pressure of second permeate stream | 3.1 | bara | 1.2 | bara |
| The number of membranes in second | 1 | | — | |
| permeate separation stage | | | | |
| Flowrate of third permeate stream | 2 | Nm³/h | — | |
| Flowrate of third retentate stream | 8 | Nm³/h | 39 | Nm³/h |
| Pressure of third permeate stream | 1.2 | bara | — | |
| The number of membranes in retentate | 2 | | 16 | |
| separation stage | | | | |
| Flowrate of the permeate stream from | 8 | Nm³/h | 62 | Nm³/h |
| the retentate separation stage | | | | |
| Pressure of the permeate stream from | 1.2 | bara | 1.2 | bara |
| the retentate separation stage | | | | |

| | | |
|---|---|---|
| Total membranes | 14 | 26 |

In Example 3 and Comparative Example 3 identical membrane modules were used. It was found that in order to achieve the same high He (gas to be separated) purity and the same high product recovery as in Example 3, the total number of membranes, in sum for all three separation stages, required in Comparative Example 3, compared to Example 3, needed to be increased by 46% even though the apparatus of Comparative Example 3 used one less membrane separation stage than the inventive apparatus of Example 3. In other words, the capital expenditure investment and the maintenance work of the inventive apparatus are both lower because the required total membrane capacity are reduced. Besides, the compressor throughput of the inventive apparatus is reduced by about 52.5%, so that the operating expense/energy consumption is also lower.

### Example 4

Example 4 was intended to test the inventive apparatus for lower selective membranes.

A crude gas stream having the composition as summarized in Table 2 was introduced into the inventive multistage membrane apparatus as the one shown in FIG. 2 except that there was no compressor (5). The feed stream having the same feed pressure, the same flowrate as Example 3 was sent to the feed stream separation stage. The numbers of membrane modules and the membrane capacities used in feed stream separation stage (1), first permeate separation stage (2), retentate separation stage (3) and second permeate separation stage (4) are the same as those in Example 3. The operating temperature in all separation stages was 30° C. and the first permeate stream was re-compressed to 20 bara. As in Example 3, the first retentate stream and the fourth retentate stream were removed from the system as product streams. Compared to Example 3, Example 4 was modified merely in that the membrane selectivity for He/CH₄ in each separation stage was decreased by 15 to 20% compared to Example 3. Details of the membrane selectivity in each separation stage are given in Table 4 below. The third permeate stream as a product stream with a volume flow rate of 2 Nm³/h and pressure of 1.2 bara had a composition of 15.21 Vol. % CH₄, 3.49 Vol. % N₂, 76.80 Vol. % He, 2.99 Vol. % H₂, 1.11 Vol. % CO₂ and 0.40 Vol. % O₂. The membrane apparatus provided a He recovery of 88.9%, which is 1.7% lower than Example 3. The recovered He purity is also about 2% lower than Example 3. Therefore, Example 3 and Example 4 confirm that the inventive apparatus leads to improvement of the purity and recovery of the component intended to be separated if higher selective membranes are used.

TABLE 4

| Membrane | | | | | | | |
|---|---|---|---|---|---|---|---|
| selectivity for | | | | | | | |
| He/CH₄, | | | | | | | |
| determined | | | | | | | |
| at 22-25° C. | | | | Comp. | | Comp. | |
| and 11 bar, | Ex. 3 | Ex. 4 | Ex. 1 | Ex. 1 | Ex. 2 | Ex. 2 | Ex. 5 |
| Feed stream | 186 | 158 | 178 | 178 | 178 | 178 | 129 |
| separation | | | | | | | |
| stage (1) | | | | | | | |
| First permeate | | | 178 | 178 | 178 | 178 | 172 |
| separation | | | | | | | |
| stage (2) | | | | | | | |
| Retentate | | | NA | NA | 178 | 178 | NA |
| separation | | | | | | | |
| stage (3) | | | | | | | |
| Second permeate | | | 178 | NA | 178 | NA | 178 |
| separation | | | | | | | |
| stage (4) | | | | | | | |

### Example 5

Example 5 was intended to test the inventive apparatus at high flow rates and high operating pressures.

A crude gas stream having the composition as summarized in Table 5 was introduced into the inventive multistage membrane apparatus as the one shown in FIG. 1 except that there was no compressor (5) in the multistage membrane apparatus of Example 5. The crude gas stream without additional compression was directly fed into the feed stream separation stage (1), having a membrane capacity of 33900000 He GPU·m². The feed pressure of the system was 60 bara. The feed stream was applied to the feed stream separation stage (1) at flowrate of 350000 Nm³/h. These settings led to a first retentate stream at flowrate of 349517 Nm³/h having a content of 99.28 Vol. % methane, 0.45 Vol. % N₂, 0.001 Vol. % C3H8, 0.01 Vol. % He, 0.007 Vol. % CO2, 0.002 Vol. % H2 and 0.25 Vol. % C₂H₆. The permeate of feed stream separation stage (1) had a volume flow rate of 47625 Nm³/h with a controlled pressure drop to 1.3 bara by the pressure-control valve 2 (8), and was thus re-compressed by the compressor (6) to a pressure of 61.02 bara and then fed into the first permeate separation stage (2), having a membrane capacity of 490000 He GPU·m². The second retentate stream from the first permeate separation stage (2) having a volume flow rate of 47171 Nm³/h with a composition of 95.25 Vol. % methane, 2.8 Vol. % He, 0.2 Vol. % CO₂, 0.19 Vol. % C₂H₆, 0.9 Vol. % H₂ and 0.66 Vol. % N₂ was recycled back to the feed stream. The permeate of first permeate separation stage (2) having a volume flow rate of 1038 Nm³/h with a controlled pressure drop to 4.1 bara by the pressure-control valve 5 (11), was further fed into the second permeate separation stage (4), having a membrane capacity of 820000 He GPU·m². Thus, a third permeate stream having a volume flow rate of 483 Nm³/h, with a composition of 9.6 Vol. % methane, 0.1 Vol. % N₂, 68.7 Vol. % He, 19.3 Vol. % H₂ and 2.3 Vol. % CO₂, was obtained. The third retentate stream from the second permeate separation stage (4) with flowrate of 556 Nm³/h was fed into the first permeate stream and compressed again. This inventive multistage membrane apparatus provided a He recovery of 90.3%.

Accordingly, the inventive apparatus is applicable at high flow rates and high operating pressures.

TABLE 5

| composition | Vol. % | Comment |
|---|---|---|
| He | 0.105 | Gas to be separated |
| CH₄ | 99.154 | Main remaining gas |
| N₂ | 0.448 | Further gas component |
| CO₂ | 0.01 | Further gas component |
| C2H6 | 0.25 | Further gas component |
| C3H8 | 0.001 | Further gas component |
| H2 | 0.032 | Further gas component |

### Example 6

In Example 6, the inventive apparatus was tested with wellhead gas. A crude gas stream having the composition as summarized in Table 6 was introduced into the inventive multistage membrane apparatus of Example 6, which was the same as the one shown in FIG. 2 except that there was no compressor (5) in the multistage membrane apparatus of Example 6. The crude gas stream without additional compression was directly fed into the feed stream separation stage (1), having a membrane capacity of 57000 CO₂ GPU·m². The feed pressure of the system was 20 bara. The setting led to a first retentate stream having a content of 78.3 Vol. % CH₄, 2.83 Vol. % CO₂, 0.12 Vol. % N₂, 12.75 Vol. % C₂H₆, 4.12 Vol. % C₃H₈, 1.52 Vol. % C₄H₁₀, 0.35 Vol. % C₅H₁₂ and 0.01 Vol. % C₆₊. The permeate of the feed stream separation stage (1) with a pressure drop to 1.3 bara controlled by the pressure-control valve 2 (8), was thus re-compressed by the compressor (6) to a pressure of bara and then fed into the first permeate separation stage (2), having a membrane capacity of 6300 CO₂ GPU·m². The fourth retentate stream from the retentate separation stage (3), having a membrane capacity of 12600 CO₂ GPU·m², with a composition of 84.9 Vol. % CH₄, 1.56 Vol. % CO₂, 0.19 Vol. % N₂, 10.16 Vol. % C₂H₆, 2.2 Vol. % C₃H₈, 0.8 Vol. % C₄H₁₀ and 0.19 Vol. % C₅H₁₂ was removed from the system as product stream. The permeate of first permeate separation stage (2) with a pressure drop to 4.1 bara controlled by the pressure-control valve 5 (11) was further fed into the second permeate separation stage (4), having a membrane capacity of 12600 CO₂ GPU·m². Thus, a third permeate stream with a composition of 2.6 Vol. % CH₄, 97.2 Vol. % CO₂ 0.2 Vol. % C₂H₆ was obtained. The third retentate stream from the second permeate separation stage (4) was combined with the fourth permeate stream from the retentate separation stage (3) and with the first permeate stream and re-compressed with compressor (6) as described above. Details of the membrane selectivity in each separation stage are given in Table 7 below. This inventive multistage membrane apparatus provided a hydrocarbon yield higher than 99.5%. At the same time, carbon dioxide with higher than 95% purity was recovered as a by-product with the third permeate stream. This shows that the inventive apparatus is advantageous to separate carbon dioxide from wellhead gas.

TABLE 6

| composition | Vol. % | Comment |
|---|---|---|
| CO₂ | 10.55 | Gas to be separated |
| CH₄ | 72.48 | Main remaining gas |
| N₂ | 0.12 | Further gas component |
| C₂H₆ | 11.53 | Further gas component |
| C₃H₈ | 3.65 | Further gas component |
| C₄H₁₀ | 1.35 | Further gas component |
| C₅H₁₂ | 0.31 | Further gas component |
| C₆₊ | 0.01 | Further gas component |

TABLE 7

| Membrane selectivity for CO₂/CH₄, | |
|---|---|
| determined at 22-25° C. and 11 bar | Example 6 |
| Feed stream separation stage (1) | 50 |
| First permeate separation stage (2) | 52 |
| Retentate separation stage (3) | 52 |
| Second permeate separation stage (4) | 52 |

The above description is presented to enable a person skilled in the art to make and use the invention and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown but is to be accorded the widest scope consistent with the principles and features disclosed herein. In this regard, certain embodiments within the invention may not show every benefit of the invention, considered broadly.

As used herein, terms such as “comprise(s)” and the like as used herein are open terms meaning ‘including at least’ unless otherwise specifically noted.

All references, tests, standards, documents, publications, etc. mentioned herein are incorporated herein by reference. Where a numerical limit or range is stated, the endpoints are included. Also, all values and subranges within a numerical limit or range are specifically included as if explicitly written out.

### Comparative Example 4

In Comparative Example 4 the process according to CN 212292809 U, FIG. 3 was reproduced. A crude gas having a composition as shown in Table 1 above was compressed by a first compressor (131 in CN'809U, FIG. 3) and fed into a feed stream separation stage (111 in CN'809U, FIG. 3) having a membrane capacity of 1186250 He GPU·m². The pressure of the compressed crude gas stream, i.e. the feed stream of the feed stream separation stage, was set to 18.0 bara. From the feed stream separation stage a first retentate stream having a content of 88.8 Vol. % methane, 11.0 Vol. % N₂, 0.1 Vol. % He and 0.1 Vol. % in sum from H₂ and CO₂ and a first permeate stream were obtained. The permeate pressure at the permeate gas outlet of the feed stream separation stage was set to 4 bara. The first permeate stream was, without re-compression, fed into the first permeate separation stage (112 in CN'809U, FIG. 3), having a membrane capacity of 593000 He GPU·m², and separated to obtain a second retentate stream and a second permeate stream. The second retentate stream had a composition of 74.5 Vol. % methane, 14.9 Vol. % N₂, 9.4 Vol. % He, 1.1 Vol. % H₂ and 0.0 Vol. % CO₂ and was recycled to the crude gas stream. The pressure of the second permeate stream was set to 1.2 bara. The second permeate stream was recompressed by a second compressor to 7 bara and fed to a second permeate separation stage (113 in CN'809U, FIG. 3), having a membrane capacity of 45500 He GPU·m², where it was separated to obtain a 3^{rd} permeate stream and a 3^{rd} retentate stream. The third permeate stream was fed to a third permeate separation stage (115 in CN'809U, FIG. 3), having a membrane capacity of 45500 He GPU·m² and a fourth permeate stream as well as a fourth retentate stream were obtained. The fourth permeate stream had a composition of 4.6 Vol. % methane, 2.4 Vol. % N₂, 83.6 Vol. % He, 9.2 Vol. % H₂ and 0.2 Vol. % CO₂. The third retentate stream was recycled to the first permeate stream and the fourth retentate stream was recycled to the second permeate stream on the up-stream side of the second compressor. He recovery was 96.8%.

The process of Comparative Example 4 deviates from the process according to inventive Example 1 in that
a) The first permeate stream was re-compressed in inventive Example 1 but not in Comparative Example 4
b) The second permeate stream was not re-compressed in inventive Example but was re-compressed in Comparative Example 4
c) A third permeate separation stage was used in Comparative Example 4, i.e. FIG. 3 of CN'809U, which is not needed in the process of the invention.

The raw gas streams in inventive Example 1 and Comparative Example 4 were identical. The compositions of the retentate respectively the permeate product streams in inventive Example 1 and Comparative Example 4 were controlled to be very similar. Thus, Comparative Example 4 allows a fair comparison of the process of the invention to the process disclosed in CN212292809U. The comparison shows that the membrane capacity needed in inventive Example 1, which is 546500 He GPU·m², is much lower than in Comparative Example 4, which is 1871250 He GPU·m². Thus, to convert the same amount of an identical crude gas stream into very similar product streams, the process of the invention requires only 30% of the membrane capacity that is needed in the process of CN212292809U. In other words, the membrane costs of the process of the invention are 70% lower compared to CN212292809U.

### Comparative Example 5

In Comparative Example 5 the process according to U.S. Pat. No. 11,285,434 B2, FIG. 1 was reproduced. A crude gas having a composition a shown in Table 1 above was compressed by a first compressor and fed into a feed stream separation stage (20 in US'434, FIG. 1) having a membrane capacity of 365000 He GPU·m². The pressure of the compressed feed stream was 18.1 bara. From the feed stream separation stage a first retentate stream having a content of 88.8 Vol. % methane, 11.0 Vol. % N₂, 0.1 Vol. % He and 0.1 Vol. % CO₂ plus H₂ in sum and a first permeate stream were obtained. The permeate pressure at the permeate gas outlet of the feed stream separation stage was set to 1.2 bara. The first permeate stream was recompressed with a second compressor (14 in US'434, FIG. 1) to 19.1 bar (a). The recompressed first permeate stream was fed into the first permeate separation stage (22 in US'434, FIG. 1), having a membrane capacity of 45500 He GPU·m², and separated to obtain a second retentate stream and a second permeate stream. The second retentate stream had a composition of 78.6 Vol. % methane, 14.9 Vol. % N₂, 5.67 Vol. % He, 0.79 Vol. % H₂ and 0.02 Vol. % CO₂ and was recycled to the feed stream of the first separation stage, i.e. between the gas outlet of the first compressor and the gas inlet of the first separation stage. The pressure of the second permeate stream was set to 3.1 bara. The second permeate stream was, without further recompression, fed to a second permeate separation stage (24 in US 434, FIG. 1), having a membrane capacity of 45500 He GPU·m², where it was separated to obtain a 3^{rd} permeate stream and a 3^{rd} retentate stream. The third permeate stream was withdrawn as permeate product stream and had a composition of 4.8 Vol. % methane, 2.0 Vol. % N₂, 83.7 Vol. % He, 9.3 Vol. % H₂ and 0.2 Vol. % CO₂. The third retentate stream was recycled to the crude gas stream, i.e. up-stream of the first compressor. He recovery was 96.8%.

The process of Comparative Example 5 deviates from the process according to inventive Example 1 as follows:
a) In Comparative Example 5 the second retentate stream is recycled to the feed stream of the first separation stage, i.e. between the gas outlet of the first compressor, while in the present invention it is recycled to the crude gas stream.
b) In Comparative Example 5 the third retentate stream is recycled to the crude gas stream, while in the present invention it is recycled to the first permeate stream, i.e. to the low pressure feed side of the second compressor.

The raw gas streams in inventive Example 1 and Comparative Example 5 were identical. The compositions of the retentate respectively the permeate product streams in inventive Example 1 and Comparative Example 5 were controlled to be very similar. Thus, Comparative Example 5 allows a fair comparison of the process of the invention to the process disclosed in U.S. Pat. No. 11,825,434 B2. The comparison shows that the membrane capacity needed in inventive Example 1 is around 17% higher than in Comparative Example 5. On the other hand, the energy required by the two compressors in inventive Example 1 is 90% lower than in Comparative Example 5. Thus, to convert the same amount of an identical crude gas stream into very similar product streams, the process of the invention requires 17% higher invest costs but leads to 90% lower operational costs, which over the time significantly overcompensates the higher invest costs.

The effect of differentiating feature b) is that the process of U.S. Pat. No. 11,285,434 B2 can only be operated with two compressors if low pressure crude gases are used. If the crude gas is on high pressure, a third compressor to recompress the third retentate stream for recycling would be needed. In the process of the invention such third compressor would not be needed even if the crude gas is on high pressure. Thus, the process of the invention is much mor flexible regarding the crude gas pressure than the process of U.S. Pat. No. 11,285,434 B2.

### LIST OF REFERENCES

(1) feed stream separation stage
(2) first permeate separation stage
(3) retentate separation stage
(4) second permeate separation stage
(5) optional second compressor
(6) compression unit
(7) pressure control valve 1
(8) pressure control valve 2
(9) pressure control valve 3
(10) pressure control valve 4
(11) pressure control valve 5
(12) raw gas stream conduit
(13) first retentate stream conduit
(14) first permeate stream conduit
(15) gas conduit
(16) second retentate stream conduit
(17) second permeate stream conduit
(18) third retentate stream conduit
(19) third permeate stream conduit
(20) fourth retentate stream conduit
(21) fourth permeate stream conduit
(22) feed stream conduit
(23) compressed permeate gas conduit

1-16. (canceled)

17. A multistage membrane apparatus comprising: a feed stream separation stage (1); a first permeate separation stage (2); a second permeate separation stage (4); a compression unit (6); and gas conduits; wherein:
a feed stream conduit (22) is connected to a raw gas stream conduit (12), which is connected to and a gas inlet of the feed stream separation stage (1);
a first permeate stream conduit (14) is connected to a permeate gas outlet of the feed stream separation stage (1), which is connected to and a gas inlet of the compression unit (6);
a compressed permeate gas conduit (23) is connected to a gas outlet of the compression unit (6) and to the gas inlet of the first permeate separation stage (2);
a first retentate stream conduit (13) is connected to a retentate gas outlet of the feed stream separation stage (1);
a second permeate stream conduit (17) is connected to a permeate gas outlet of the first permeate separation stage (2) and to a gas inlet of the second permeate separation stage (4);
a second retentate stream conduit (16) is connected to a retentate gas outlet of the first permeate separation stage (2);
a third permeate stream conduit (19) is connected to a permeate gas outlet of the second permeate separation stage (4);
a third retentate stream conduit (18) is connected to a retentate gas outlet of the second permeate separation stage (4) and to the first permeate stream conduit (14), up-stream of compression unit (6), or directly to compression unit (6);
and wherein:
each separation stage (1), (2) and (4) is a membrane separation stage with gas separation membranes;
the feed stream separation stage (1) is configured to separate a feed stream comprising a gas to be separated, a main remaining gas and optionally one or more further gas components into a first permeate stream and a first retentate stream;
the first permeate separation stage (2) is configured to separate the compressed gas stream obtained from compression unit (6), into a second permeate stream and a second retentate stream;
the second permeate separation stage (4) is configured to separate the second permeate stream into a third permeate stream and a third retentate stream;
and wherein said multistage membrane apparatus does not comprise a compressor in the second permeate stream conduit (17) between the first permeate separation stage (2) and the second permeate separation stage (4).

18. The multistage membrane apparatus of claim 17, wherein the second retentate stream conduit (16) is connected to the retentate gas outlet of the first permeate separation stage (2) and to the feed stream conduit (22).

19. The multistage membrane apparatus of claim 18, wherein feed stream conduit (22) comprises a compressor (5) and the second retentate stream conduit (17) is fed to a connection point up-stream of compressor (5), to the raw gas stream conduit (12) or to a gas removal device.

20. The multistage membrane apparatus of claim 17, wherein the apparatus further comprises:
a retentate separation stage (3) that is connected to the retentate gas outlet of the first permeate separation stage (2) via the second retentate stream conduit (16), wherein the retentate separation stage (3) is configured to separate the second retentate stream into a fourth permeate stream in a fourth permeate stream conduit (21) connected to a permeate gas outlet of the retentate separation stage (3); and
a fourth retentate stream in a fourth retentate stream conduit (20), wherein the fourth retentate stream conduit (20) is connected to a retentate gas outlet of the retentate separation stage (3).

21. The multistage membrane apparatus of claim 20, wherein retentate separation stage (3) is also connected to the third retentate stream conduit (18) up-stream of the compression unit (6), to the first permeate stream conduit (14) up-stream of the compression unit (6) or to compression unit (6) itself.

22. The multistage membrane apparatus of claim 20, wherein the apparatus is configured such that fourth retentate stream conduit (20) is connected to the retentate gas outlet of the retentate separation stage (3) and to the feed stream conduit (22).

23. The multistage membrane apparatus of claim 17, wherein a second compressor (5) is located between the raw gas stream and the feed stream.

24. The multistage membrane apparatus of claim 23, wherein the feed stream conduit (22) the fourth retentate stream conduit (20) is fed to a connection point up-stream of compressor (5), or to the raw gas stream conduit (12).

25. The multistage membrane apparatus of claim 17, wherein the membrane capacity of first separation stage is the highest membrane capacity of all membranes used in the apparatus and/or the membrane with the highest permeance for the gas to be separated compared to all membranes in the apparatus is in the first separation stage.

26. The multistage membrane apparatus of claim 17, wherein the ratio of the membrane capacity of the feed stream separation stage to the membrane capacity of the first permeate stream separation stage is equal to or greater than 2 and/or the ratio of the membrane capacity of the feed stream separation stage to the membrane capacity of the second permeate stream separation stage is equal to or greater than 2.

27. The multistage membrane apparatus of claim 17, wherein the gas separation membranes are hollow fiber membranes or spiral wound membranes and wherein the gas separation membranes comprise a separation-active layer of a material selected from the group consisting of: polyamides, polyetherimides, polyaramides, polybenzoxazoles, polybenzothiazoles, polybenzimidazoles, polysulfones, cellulose acetate, cellulose acetate derivatives, polyphenylene oxides, polysiloxanes, polymers with intrinsic microporosity, mixed matrix membranes, facilitated transport membranes, polyethylene oxides, polypropylene oxides and polyimides.

28. The multistage membrane apparatus of claim 17, wherein the gas separation membranes comprise a separation-active layer of a polyimide of structure (I): 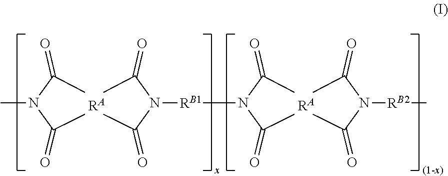
wherein the aromatic dianhydride monomer units R^{A}, independently of one another, are selected from the group consisting of: 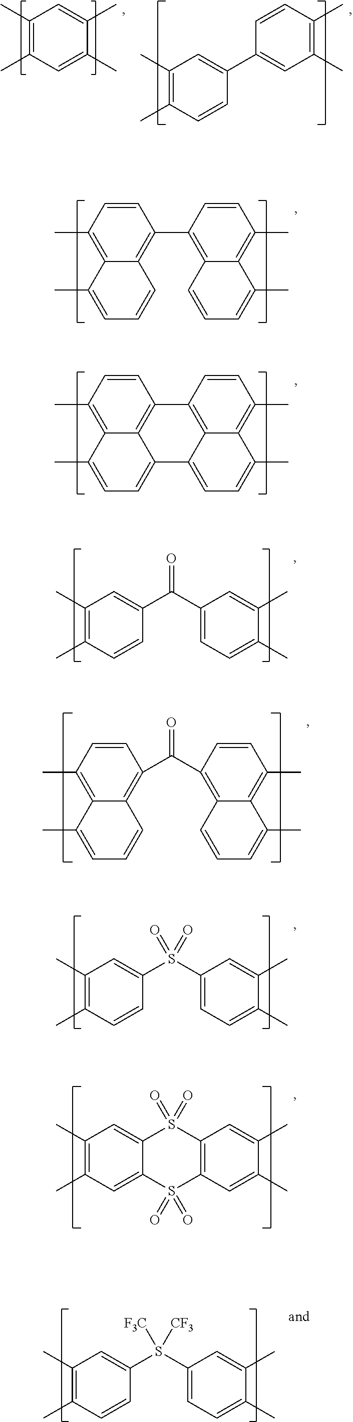 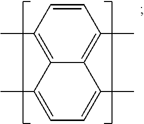
the aromatic diamine monomer units R^{B1}, independently of one another, are selected from the group consisting of: 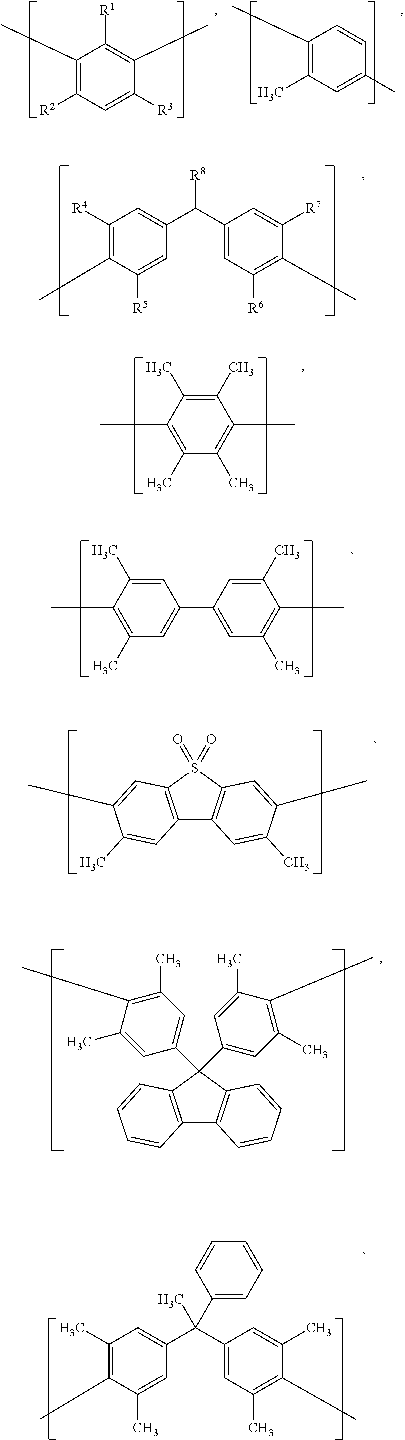 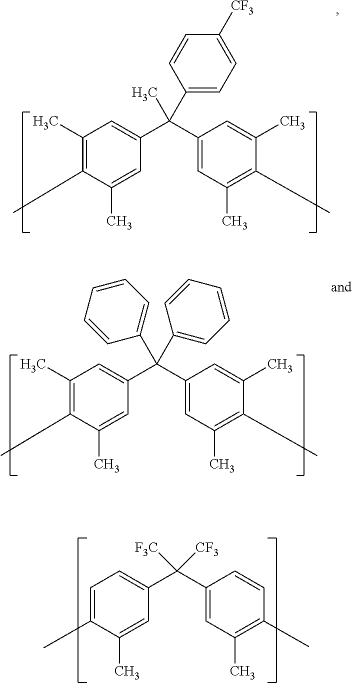
wherein each R¹ to R⁷ is, independently of each other, hydrogen or a methyl group, with the proviso that at least one of R¹ to R³ is different from hydrogen, and at least one of R⁴ to R⁷ is different from hydrogen;
R⁸ is hydrogen or a C₁ to C₃ alkyl group unsubstituted or substituted by one or more halogen groups or methyl;
and the aromatic diamine monomer units R^{B2}, independently of one another, are selected from the group consisting of: 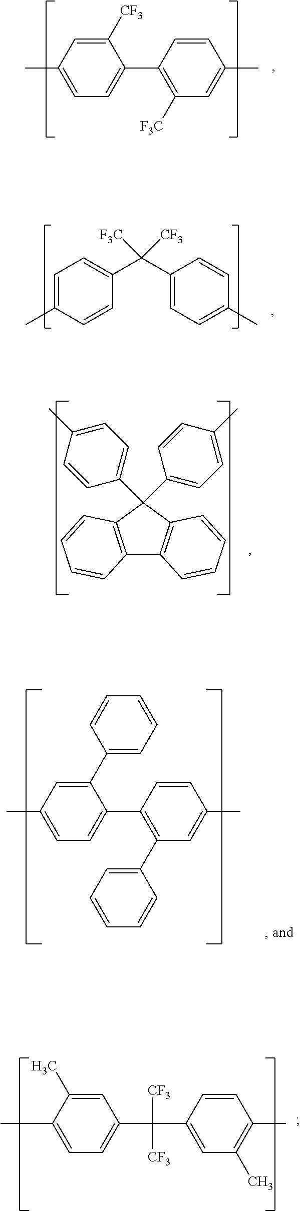
and wherein x is from 0.1 to 1.

29. The multistage membrane apparatus of claim 17, further comprising one or more identical or different control valves which are used to adjust the pressures of the gas streams within the apparatus.

30. A method for separating a gas and a main remaining gas from a raw gas stream comprising the gas to be separated, the main remaining gas and optionally one or more further gas components, wherein the method is carried out in the multistage membrane apparatus of claim 17, and said method comprises the following steps:
a) a raw gas stream is fed to a feed stream that is fed to the feed stream separation stage where the raw gas stream is separated into a first permeate stream and a first retentate stream, wherein the first retentate stream is removed from the multistage membrane apparatus as a second product, further processed or discarded;
b) the first permeate stream is compressed with compression unit (6) such that after compression, said compressed first permeate stream is fed into the first permeate separation stage (2), where it is separated to a second permeate stream and a second retentate stream;
c) the second permeate stream is fed, without compression, into the second permeate separation stage (4) where it is separated to a third permeate stream and a third retentate stream, and wherein the third permeate stream is removed from the multistage membrane apparatus as first product stream, further processed, or removed from the multistage membrane apparatus and thereafter further processed; and
d) the third retentate stream is fed to the first permeate stream to obtain a combined gas stream that is fed to compression unit (6) or the third retentate stream is fed directly to the compression unit (6).

31. The method of claim 30, wherein the second retentate stream is recycled to the feed stream, recycled to the raw gas stream, further processed in the multistage membrane apparatus, or removed from the multistage membrane apparatus as a third product, discarded, or combined with the first retentate stream.

32. The method of claim 30, wherein the gas to be separated is enriched in the third permeate stream compared to the raw gas stream and/or the second retentate stream is fed to the crude gas stream.

33. The method of claim 30, wherein the membrane capacities of the separation stages are selected such that the membrane with the highest membrane capacity of all membranes is used the first separation stage, and/or the membrane with the highest permeance for the gas to be separated compared to all membranes is used in the first separation stage.

34. The method of claim 30, wherein the multistage membrane apparatus further comprises a retentate separation stage (3), wherein:
i) the second retentate stream is separated into a fourth permeate stream and a fourth retentate stream in the retentate separation stage (3);
ii) the fourth permeate stream is combined with the first permeate stream and/or the third retentate stream to obtain a combined gas stream that is fed to compression unit (6); and
iii) the fourth retentate stream is recycled to the feed stream or the raw gas stream, further processed in the multistage membrane apparatus, removed from the multistage membrane apparatus, combined with the first retentate stream or discarded.

35. The method of claim 30, wherein the first permeate stream, a gas stream obtained by combining the third retentate stream and the first permeate stream or a gas stream obtained by combining the third retentate stream, the first permeate stream and the fourth permeate stream is compressed in the compression unit (6) to a pressure in the range of 5 to 200 bara.

36. The method of claim 30, wherein the gas to be separated is selected from the group consisting of helium, hydrogen and carbon dioxide, and/or wherein the main remaining gas is a hydrocarbon gas.
